(19) United States
(12) Patent Application Publication
(10) Pub. No.: US 2003/0088628 A1
(43) Pub. Date: May 8, 2003

(54) Input device for notifying received electronic mail

(76) Inventor: Yong-Sheng Lin, Xin-Zhuang City (TW)

Correspondence Address: Raymond Sun, 12420 Woodhall Way, Tustin, CA, 92782, US

(21) Appl. No.: 10/000,870

(22) Filed: Nov. 2, 2001

(51) Int. Cl. G06F 15/16

(52) U.S. Cl. 709/206

(57) ABSTRACT

A computer system has an e-mail server, a computer having an input device driving program coupled to the e-mail server, and an input device. The input device has a processor coupled to the input device driving program, and a notifying device coupled to the processor for notifying a user of the arrival of an e-mail that has been received at the e-mail server.

### BACKGROUND OF THE INVENTION

1. Field of the Invention

The present invention relates to an input device, and in particular, to an input device that notifies the user of received electronic mail.

2. Description of the Prior Art

The number of computer users has increased rapidly. In addition, the Internet is further encouraging increased use of computers through the numerous applications that are now available via the Internet. However, conventional input devices (e.g., keyboards and computer mice) are still not very user-friendly in that they are not completely responsive to all the new and increased applications and capabilities offered by the Internet and electronic mail.

For example, for a user to find out if he or she has received an electronic mail (e-mail), the user must log on to the e-mail server. To a user who frequently receives important messages via email, it is important for a user to know when an e-mail message has arrived so that the user can avoid any delays in reviewing and responding to the e-mail. To require such a user to continually log-on to the e-mail server to check for such messages will be an inconvenient burden.

Therefore, there still remains a need for an input device that avoids the drawbacks described above.

### SUMMARY OF THE DISCLOSURE

It is an object of the present invention is to provide an input device that notifies the user of received electronic mail.

In order to accomplish the objects of the present invention, the present invention provides a computer system that has an e-mail server, a computer having an input device driving program coupled to the e-mail server, and an input device. The input device has a processor coupled to the input device driving program, and a notifying device coupled to the processor for notifying a user of the arrival of an e-mail that has been received at the e-mail server.

### BRIEF DESCRIPTION OF THE DRAWINGS

FIG. 1 is a general block diagram of a system according to one embodiment of the present invention.

FIG. 2 is a flow chart illustrating the input device driving program according to one embodiment of the present invention.

FIG. 3 is a top plan view of a keyboard which embodies the principles of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

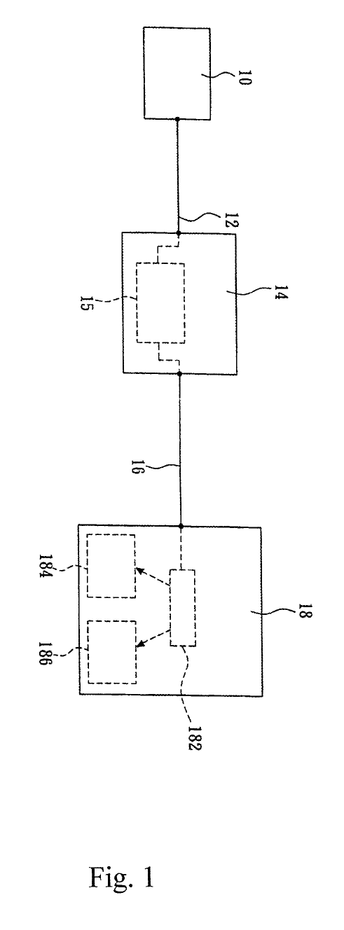

FIG. 1 is a composition block diagram of a system according to one embodiment of the present invention. A computer 14 is connected with an e-mail server 10 via a web interface 12. The web interface 12 includes a telephone line, a cable, LAN, and a wireless communication system (eg., WAP—GPRS—PHS). The computer 14 has an input device driving program 15 that is coupled to an input device 18 through an input device connecting interface 16. The input device connecting interface 16 can include one or more of the following interfaces: PS2, USB, and wireless communication interface (e.g., radio frequency, infrared rays, ultrasonic waves, blue tooth, etc.) such that the driving program 15 can control the processor 182 within the input device 18. The processor 182 is coupled to a light emitting diode (LED) 184 and/or a buzzer 186 to control the LED 184 and/or the buzzer 186 to notify the user that an e-mail has arrived and was received at the e-mail server 10.

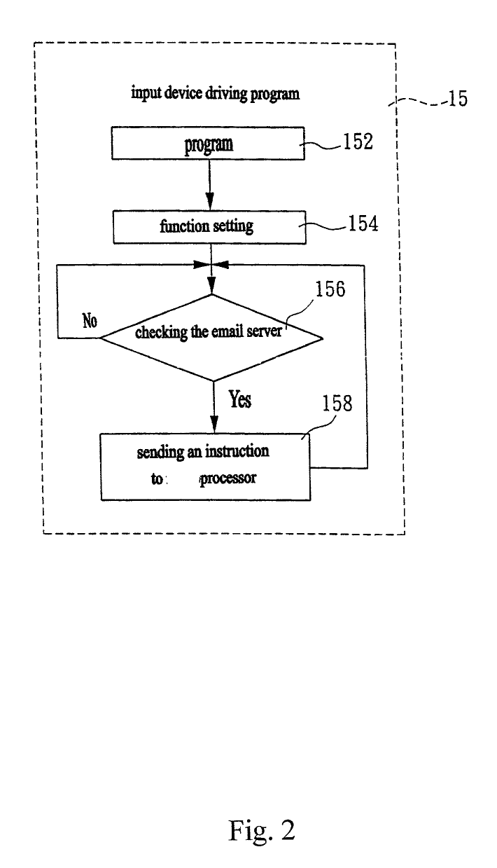

FIG. 2 illustrates a flow diagram of the input device driving program 15. The user can enter the program 15 using a keyboard or computer mouse, and execute a program 152 to modify the function setting 154 to be adapted to the user. The function setting 154 allows the following features, among others, to be set:

1) Setting at least an e-mail server address;

2) Checking at least an e-mail address;

3) Selecting the manner (i.e., by LED 184 and/or buzzer 186) to notify the user;

4) Setting the time interval for checking newly-arrived e-mails at the e-mail server 10; and

5) To activate or turn off the function of notifying a user of received e-mail.

After the desired features have been set at the function setting 154, the driving program 15 will perform the step “checking the e-mail server” 156 to see if there is a new e-mail that has been received at the e-mail server 10. The step 156 can be performed on a continuous basis, or after predetermined time intervals, depending on the function settings 154 previously selected by the user. If a new e-mail has been received at the e-mail server 10, then the driving program 15 will proceed with the step “sending an instruction to processor” 158, in which an instruction is sent via the input device connecting interface 16 so that one or more of the notifying devices (i.e., LED 184 and/or buzzer 186, depending on the function settings 154 previously selected by the user) will be activated to notify the user of the newly-arrived e-mail. After sending the notifying instruction, the driving program 15 will return operation to step 156 to detect the next e-mail that is to be received.

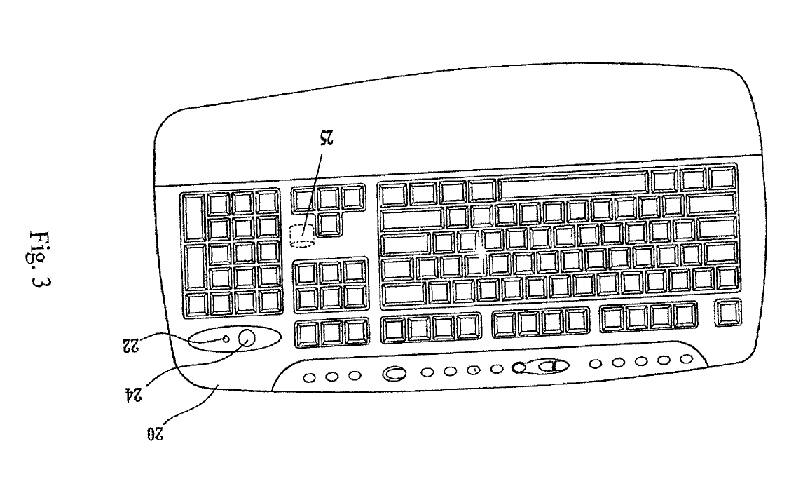

The input device 18 according to the present invention can be selected from any kind of input device, pointing device or the like, such as but not limited to a keyboard, a mouse, a trackball, a joy stick, a game controller, a PC camera, a digital video camera, and a digital camera, etc. FIG. 3 illustrates one embodiment where a keyboard 20 is used as the input device, with the LED 22 and the buzzer 24 being randomly positioned on the surface of the keyboard 20. If there is a new received e-mail, the LED 22 may light up or flash, and/or the buzzer 24 may keep buzzing so as to warn or remind the user to read the just-received e-mail. As a further alternative, the notifying device can be a vibrator 25 which generates vibration to notify the user. The vibrator 25 can also be coupled to the processor 182.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A computer system, comprising:
an e-mail server;
a computer having an input device driving program coupled to the e-mail server; and
an input device having a processor coupled to the input device driving program, and a notifying device coupled to the processor for notifying a user of the arrival of an e-mail that has been received at the e-mail server.

2. The system of claim 1, wherein the notifying device is a buzzer.

3. The system of claim 1, wherein the notifying device is a light device.

4. The system of claim 1, further including a web interface for coupling the input device driving program to the e-mail server.

5. The system of claim 4, wherein the web interface is a wireless communication interface.

6. The system of claim 1, further including an interface for coupling the input device driving program to the processor in the input device.

7. The system of claim 6, wherein the interface is a wireless communication interface.

8. The system of claim 6, wherein the interface is a PS2 interface.

9. The system of claim 6, wherein the interface is a USB interface.

10. The system of claim 6, wherein the interface is a blue tooth interface.

11. The system of claim 1, wherein the notifying device is a vibrator.

12. An input device that is coupled to a computer that is coupled to an e-mail server, the input device comprising:
a processor; and
a notifying device coupled to the processor for notifying a user of the arrival of an e-mail that has been received at an e-mail server.

13. The device of claim 12, wherein the notifying device is a buzzer.

14. The device of claim 12, wherein the notifying device is a light device.

15. The device of claim 12, wherein the notifying device is a vibrator.

16. A method of notifying a user of the arrival of an e-mail that has been received at an e-mail server, comprising:
coupling a computer to an e-mail server;
coupling an input device to the computer, the input device having a notifying device;
checking for the presence of a newly-arrived e-mail at the e-mail server; and
activating the notifying device upon the detection of the presence of a newly-arrived e-mail at the e-mail server.

17. The method of claim 16, further including:
setting certain selected function settings relating to the detection and notifying of newly-arrived e-mails.

18. The method of claim 17, wherein the function settings include setting an e-mail server address, checking an e-mail address, selecting a desired notifying device to notify the user, setting the time interval for checking newly-arrived e-mails at e-mail server, and activating or turn off the function of notifying a user of received e-mail.
